(19) United States
(12) Patent Application Publication
(10) Pub. No.: US 2010/0135015 A1
(43) Pub. Date: Jun. 3, 2010

(54) LED ILLUMINATION DEVICE

(75) Inventor: TAY-JIAN LIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/486,722

(22) Filed: Jun. 17, 2009

(30) Foreign Application Priority Data
Nov. 28, 2008 (CN) 200810305863.4

(51) Int. Cl. F21V 1/00; F21V 29/00

(52) U.S. Cl. 362/235; 362/373

(57) ABSTRACT

An LED illumination device includes a light-emitting module, a heat sink and an electrical module. The light-emitting module includes a light source provided with a plurality of LEDs. The heat sink includes an elongated base and a plurality of fins extending from the base. The base has a top surface and an opposite bottom surface. The fins extend upwardly from the top surface of the base. The light source is thermally attached to the bottom surface of the base. The heat sink is provided with at least one receiving space at a top side thereof. The electrical module includes at least one circuit board and two end covers. The at least one circuit board is accommodated in the at least one receiving space of the heat sink. The two end covers are arranged at two opposite ends of the heat sink.

### CROSS-REFERENCE TO RELATED APPLICATION

This application is related to a co-pending U.S. patent application entitled “LED ILLUMINATING DEVICE” (attorney docket number US23097) and filed in the same day as the instant application. The co-pending U.S. patent application is assigned to the same assignee as the instant application. The disclosure of the above-identified application is incorporated herein by reference.

### BACKGROUND

1. Technical Field

The present disclosure relates to light emitting diode (LED) illumination devices, and particularly to an LED illumination device with high heat dissipating efficiency.

2. Description of Related Art

In recent years, LEDs are preferred for use in illumination devices rather than CCFLs (cold cathode fluorescent lamps) and other traditional lamps due to LEDs excellent properties, including high brightness, long lifespan, wide color range, and etc.

For an LED, about eighty percents of the power consumed thereby is converted into heat. Generally, an LED illumination device includes a plurality of LEDs arranged on a substrate to obtain a desired brightness and illumination area. However, the plurality of LEDs generate a large amount of heat during operation which endangers the normal operation of the LEDs of the LED illumination device. A highly efficient heat dissipation device is necessary in order to timely and adequately remove the heat generated by the LED illumination device. Otherwise, the brightness, lifespan, and reliability of the LED illumination device will be seriously affected.

For the foregoing reasons, therefore, there is a need in the art for an LED illumination device which overcomes the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a longitudinal cross-sectional view of an LED illumination device in accordance with an exemplary embodiment.

FIG. 2 is a transverse cross-sectional view of the LED illumination device of FIG. 1, taken along line II-II thereof.

FIG. 3 is an isometric view of a light bar of the LED illumination device of FIG. 1.

FIG. 4 is an isometric view of an end cover of the LED illumination device of FIG. 1.

FIG. 5 is an isometric, assembled view of a heat sink and a heat pipe of the LED illumination device of FIG. 1.

FIG. 6 is a longitudinal cross-sectional view of an LED illumination device in accordance with an alternative embodiment.

FIG. 7 is a longitudinal cross-sectional view of an LED illumination device in accordance with another alternative embodiment.

### DETAILED DESCRIPTION

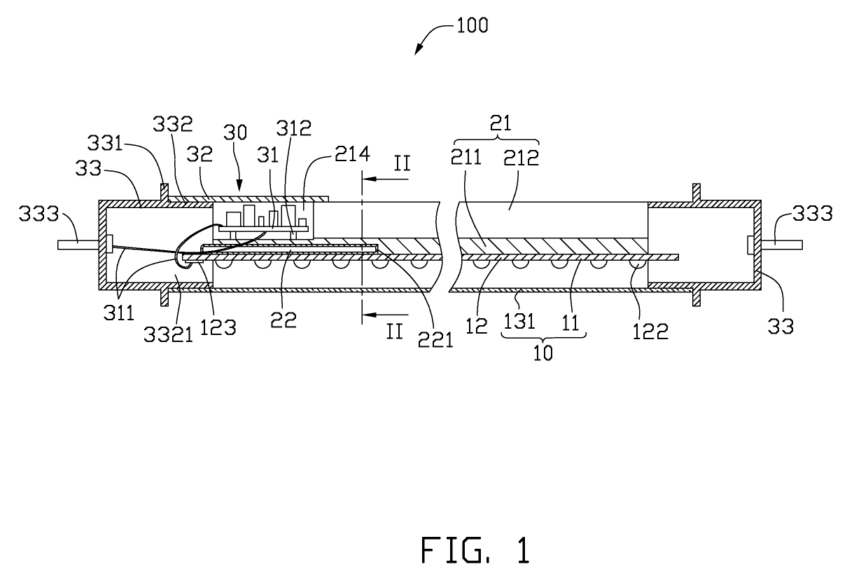

Referring to FIG. 1, an LED illumination device 100 according to an exemplary embodiment includes a light-emitting module 10, a heat sink 21 arranged above the light-emitting module 10, and an electrical module 30 electrically connected with the light-emitting module 10.

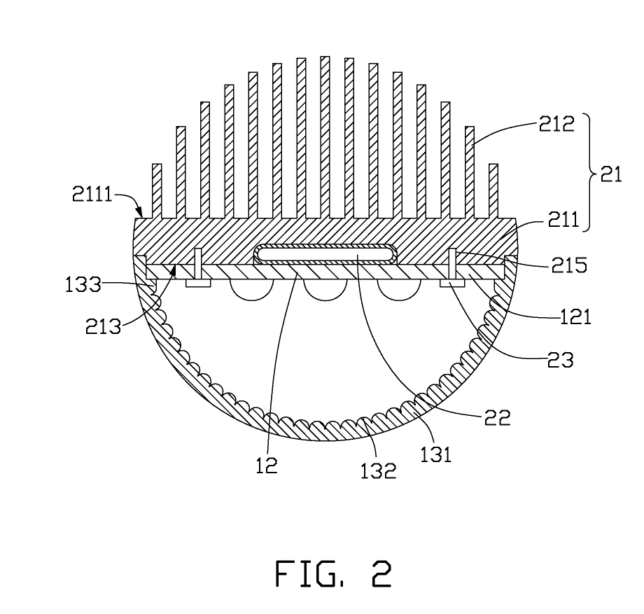

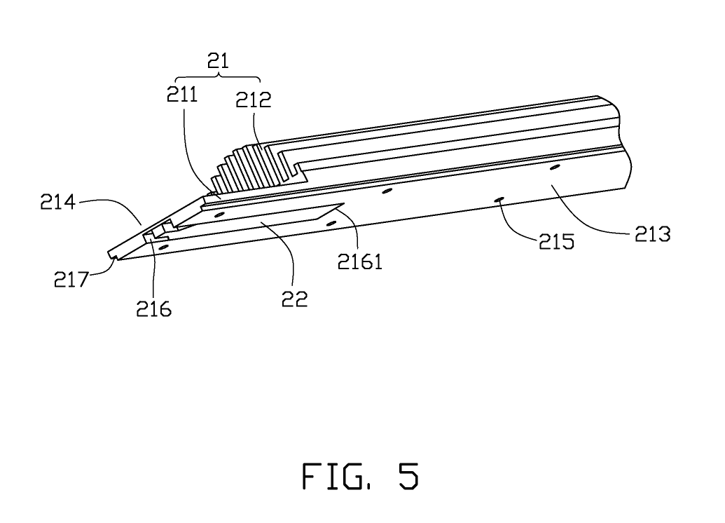

Referring also to FIGS. 2 and 5, the heat sink 21 includes an elongated metal base 211 and a plurality of spaced metal fins 212 integrally extending from the base 211. The base 211 is substantially rectangular, and has a top surface 2111 and an opposite bottom surface 213. The fins 212 extend vertically and upwardly from the top surface 2111 of the base 211, and are arranged symmetrically to a longitudinal center line of the top surface 2111. A height of the fins 212 decreases from the longitudinal center line of the top surface 2111 towards two opposite lateral sides of the base 211. Upper free ends of the fins 212 cooperatively form an imaginary arch-shaped convex surface. In other words, the fins 212 at the longitudinal center line of the top surface 2111 of the base 211 have a maximum height, and the fins 212 at the lateral sides of the base 211 have a minimum height. Thus, a heat dissipation at a longitudinal center of the heat sink 21 is enhanced.

The heat sink 21 is provided with a receiving space 214 at a top side thereof. The receiving space 214 is located adjacent to a left end of the heat sink 21, and formed by cutting out the fins 212 and a portion of base 211 at the left end of the heat sink 21. Alternatively, the receiving space 214 can be provided at other positions of the top side of the heat sink 21, such as at a center position of the top side of the heat sink 21. Still alternatively, the receiving space 214 can be integrally formed during the formation of the heat sink 21 by aluminum extrusion, wherein the fins 212 are formed to have an original length the same as that shown in FIG. 1 so that the cutting of the fins 212 for forming the receiving space 214 can be omitted. Particularly referring to FIG. 5, the base 211 of the heat sink 21 defines an elongated receiving groove 216 in the bottom surface 213 thereof. The receiving groove 216 is located under the receiving space 214 and extends along a longitudinal direction of the base 211. The receiving groove 216 has a length greater than that of the receiving space 214 whereby a right end 2161 of the receiving groove 216 extends inwardly beyond the receiving space 214 to a position under the fins 212 of the heat sink 21. A flat heat pipe 22 is provided in the receiving groove 216 of the base 211. The heat pipe 22 has a length substantially identical to that of the receiving groove 216 whereby a right end 221 of the heat pipe 22 also extends inwardly beyond the receiving space 214 of heat sink 21. A bottom surface of the heat pipe 22 is coplanar with the bottom surface 213 of the base 211.

When the heat pipe 22 is mounted to the base 211, a layer of thermal interface material (TIM) may be applied between the base 211 and the heat pipe 22 to eliminate an air interstice therebetween, to thereby enhance a heat conduction efficiency between the heat pipe 22 and the base 211. Alternatively, the heat pipe 22 can be attached to the base 211 fixedly and intimately by soldering. Further, the base 211 defines two elongated engaging grooves 217 and a plurality of fixing holes 215 in the bottom surface 213 thereof. The two engaging grooves 217 extend from a left end to a right end of the base 211 along the longitudinal direction of the base 211, and are located at the two opposite lateral sides of the base 211. The fixing holes 215 are located near the two engaging grooves 217 the base 211.

The light-emitting module 10 includes a light source 11 provided with a plurality of LEDs 122, and an elongated optical lens 131 below the light source 11. The light source 11 is attached to the bottom surface 213 of the base 211 of the heat sink 21. The bottom surface 213 of the base 211 functions as a heat-absorbing surface for the light source 11, and the top surface 2111 of the base 211 functions as a heat-spreading surface for the light source 11.

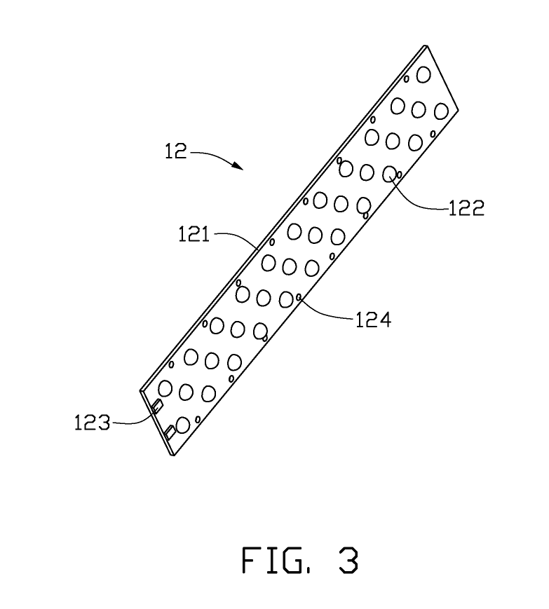

The light source 11 includes a light bar 12. Referring to FIG. 3, the light bar 12 includes an elongated substrate 121 forming electrical circuits thereon, and a pair of electrodes 123 formed at an end of the substrate 121. The plurality of LEDs 122 are arranged on the substrate 121 and evenly spaced from each other along the substrate 121. The LEDs 122 and the electrodes 123 are electrically connected to the electrical circuits formed on the substrate 121. A plurality of through holes 124 are defined near two opposite lateral sides of the substrate 121 corresponding to the fixing holes 215 of the base 211. Fixing devices 23, such as screws, extend through the through holes 124 of the substrate 121 of the light bar 12 and threadedly engage into the fixing holes 215 of the base 211, thereby to securely attach the light bar 12 to the bottom surface 213 of the base 211. The heat pipe 22 is sandwiched between the base 211 of the heat sink 21 and the substrate 121 of the light bar 12. The substrate 121 of the light bar 12 thermally contacts with the bottom surface 213 of the base 211 and the bottom surface of the heat pipe 22 at the same time.

When the light bar 12 is mounted to the bottom surface 213 of the base 211, a layer of thermal interface material (TIM) may be applied between the substrate 121 and the bottom surface 213 to eliminate an air interstice therebetween, to thereby enhance a heat conduction efficiency between the light bar 12 and the base 211. Alternatively, the substrate 121 of the light bar 12 can be attached to the bottom surface 213 of the base 211 fixedly and intimately through surface mount technology (SMT). In addition, the electrical circuits formed on the substrate 121 of the light bar 12 can be directly formed on the bottom surface 213 of the base 211, and the LEDs 122 of the light source 11 are directly attached to the electrical circuits formed on the bottom surface 213 of the base 211, whereby the substrate 121 can be omitted and a thermal resistance between the LEDs 122 and the base 211 is reduced.

The optical lens 131 is located below the light bar 12 and mounted to the base 211 of the heat sink 21. Light emitted by the LEDs 122 of the light bar 12 is guided to outer environment by the optical lens 131. The optical lens 131 has a substantially C-shaped cross section, and has a glazed outer surface and an opposite inner surface. A plurality of light guiding protrusions 132 are formed on the inner surface of the optical lens 131 and extend along an axial direction of the optical lens 131. The light guiding protrusions 132 are arranged close to each other along a circumferential direction of the optical lens 131. Light emitted by the LEDs 122 of the light bar 12 is evenly diffused to the outer environment by the light guiding protrusions 132 of the optical lens 131, to thereby expand the illumination area of the LED illumination device 100 and reduce glare from the LED illumination device 100. The optical lens 131 further forms two supporting steps 133 at two opposite lateral sides thereof. The two opposite lateral sides of the substrate 121 are tightly sandwiched between the steps 133 and the bottom surface 213 of the base 211 of the heat sink 21.

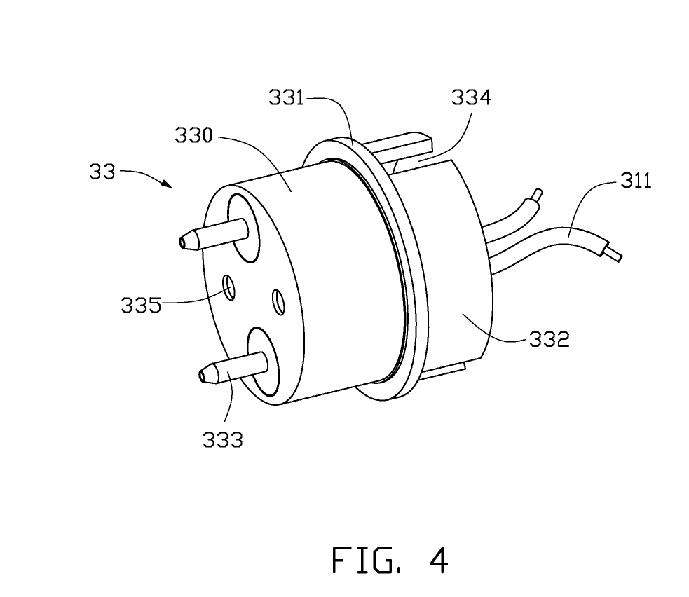

The electrical module 30, which provides drive power, control circuit and power management for the light source 11, includes a circuit board 31, two end covers 33 (i.e., left end cover and right end cover), and two pairs of pins 333. The two end covers 33 are arranged at two opposite ends of the heat sink 21. Each end cover 33 is connected with one pair of the pins 333. Referring to FIG. 4, the end cover 33 is substantially a hollow cylinder. The end cover 33 includes a mounting section 330 at an outer side thereof, a connecting section 332 at an inner side thereof, and a projecting ring 331 between the mounting section 330 and the connecting section 332. The connecting section 332 defines a receiving room 3321 (FIG. 1) therein and a pair of elongated positioning grooves 334 through inner and outer surfaces thereof. The positioning grooves 334 are arranged symmetrically to a center axis of the end cover 33, and extend from the connecting section 332 to the projecting ring 331 along an axial direction of the end cover 33. The projecting ring 331 extends radially and outwardly from an outer circumferential surface of the end cover 33, and has an outer diameter larger than those of the mounting section 330 and the connecting section 332. The pair of the pins 333 each is column-shaped and connected to an outer end surface of the mounting section 330. The pair of the pins 333 and the mounting section 330 can be used for engaging with a traditional fluorescent lamp holder to mount the LED illumination device 100 thereon. Two air venting holes 335 are axially defined in the outer end of the mounting section 330 and communicate with the receiving room 3321 of the connecting section 332.

The circuit board 31 is accommodated in the receiving space 214 of the heat sink 21 and fixed to the base 211 of the heat sink 21 via a plurality of mounting poles 312. A protecting cover 32 is provided above the circuit board 31 to cover and protect the circuit board 31.

In assembly of the LED illumination device 100, the heat pipe 22 is received in the receiving groove 216 of the base 211. The circuit board 31 is accommodated in the receiving space 214 of the heat sink 21. The light bar 12 of the light source 11 is securely and thermally attached to the bottom surface 213 of the base 211 and the heat pipe 22, with two opposite ends of the light bar 12 extending outwardly beyond two opposite ends of the heat sink 21, respectively. The circuit board 31 is electrically connected to the electrodes 123 of the light bar 12 and inner ends of the pins 333 of the left end cover 33 via a plurality of wires 311. Two opposite lateral sides of the optical lens 131 engage in the engaging grooves 217 of the base 211, respectively. The heat sink 21 and the light bar 12 are supported by the optical lens 131 via the supporting steps 133 thereof. The protecting cover 32 is arranged above the circuit board 31 and mounted to the heat sink 21. The protecting cover 32 and the optical lens 131 cooperatively form a circular tube receiving the circuit board 31 therein. The connecting section 332 of the left end cover 33 is inserted inwardly into the circular tube formed by the protecting cover 32 and the optical lens 131, till the projecting ring 331 abutting the left end of the circular tube. At the same time, two opposite lateral sides of a left end of the substrate 121 of the light bar 12 are inserted in the positioning grooves 334 of the left end cover 33. Two opposite lateral sides of a right end of the substrate 121 of the light bar 12 are inserted in the positioning grooves 334 of the right end cover 33. An outer surface of the connecting section 332 of the right end cover 33 contacts with the inner surface of the optical lens 131 and the projecting ring 331 of the right end cover 33 abuts a right end of the optical lens 131.

Alternatively, the protecting cover 32 and the optical lens 131 can be integrally formed by an elongated circular tube, with a portion of the elongated circular tube facing the fins 212 of the heat sink 21 being cut out, thereby to strengthen the structure of the LED illumination device 100 and simplify the assembly process of the LED illumination device 100.

During operation, the circuit board 31 is electrically connected to the light source 11 and the pairs of the pins 333 of the left end cover 33, whereby an external power source can supply electric current to the LEDs 122 through the pairs of the pins 333 and the circuit board 31 to cause the LEDs 122 to emit light. The light of the LEDs 122 travels through the optical lens 131 to outside for lighting.

A large amount of heat is generated by the LEDs 122 during the operation of the LED illumination device 100. As the light bar 12 of the light source 11 is thermally attached to the heat sink 21, the heat generated by the LEDs 122 can be conducted to the heat sink 21 for dissipating. The heat of the LEDs 122 is removed timely and effectively by the heat sink 21. Thus, the LEDs 122 can be kept working at a lower temperature, and the brightness, lifespan, and reliability of the LED illumination device 100 will be improved. The right end 221 of the heat pipe 22 extends to a position under the fins 212 of the heat sink 21. Thus, the heat generated by the LEDs 122 which are located under the receiving space 214 can be quickly transferred by the heat pipe 22 to the fins 212 of the heat sink 21 near the right end 221 of the heat pipe 22 for dissipation. Further, the air venting holes 335, which communicate the outer environment with the receiving room 3321 of the connecting section 32 can be utilized for dissipating heat generated by electrical components of the circuit board 31.

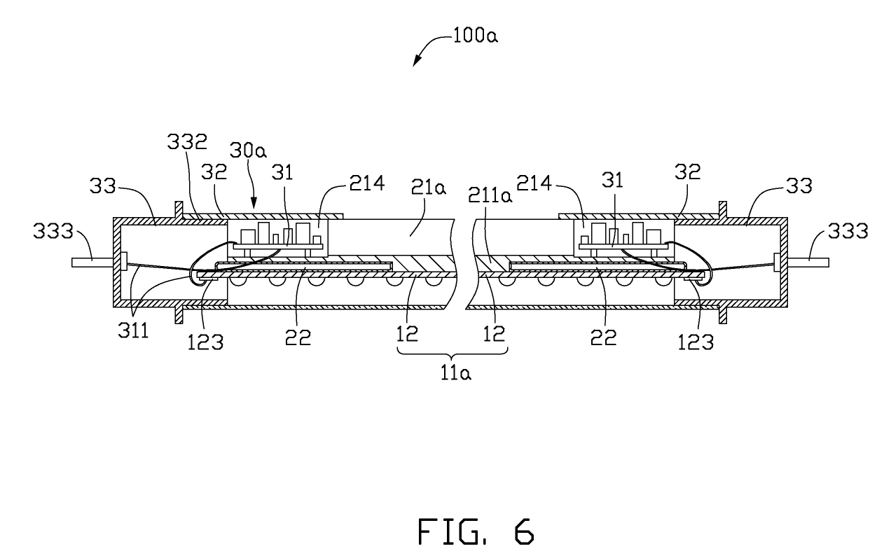

Referring to FIG. 6, an LED illumination device 100a according to an alternative embodiment is illustrated. The LED illumination device 100a includes a light source 11a, a heat sink 21 a arranged above the light source 11a, and an electrical module 30a electrically connected with the light source 11a. Except the following differences, the LED illumination device 100a of the present embodiment is essentially the same as LED illumination device 100 of the previous embodiment. In the present embodiment, the light source 11a includes two light bars 12 as shown in FIG. 3. The light bars 12 are arranged along the base 211a of the heat sink 21a. A length of the heat sink 21a is greater (approximately twice) than that of the heat sink 21 of the LED illumination device 100. The heat sink 21a defines two receiving spaces 214 at two opposite ends thereof. The electrical module 30a includes two circuit boards 31 respectively accommodated in the two receiving spaces 214 of the heat sink 21a. The two circuit boards 31 are electrically connected to the two light bars 12, respectively. Each circuit board 31 is electrically connected to the electrodes 123 of a corresponding light bar 12 and the pins 333 of a corresponding end cover 33 via wires 311. Two protecting covers 32 are arranged above the receiving spaces 214 of the heat sink 21a to cover and protect the two circuit boards 31, respectively. Two flat heat pipes 22 are arranged between the light source 11 and a base 211a of the heat sink 21a. The two heat pipes 22 are respectively located corresponding to the two receiving spaces 214, with an inner end of each heat pipe 22 extending beyond a corresponding receiving space 214 to a position under the fins 212 of the heat sink 21a. Comparing with the LED illumination device 100, the illumination area and illumination capability of the LED illumination device 100a are greatly expanded.

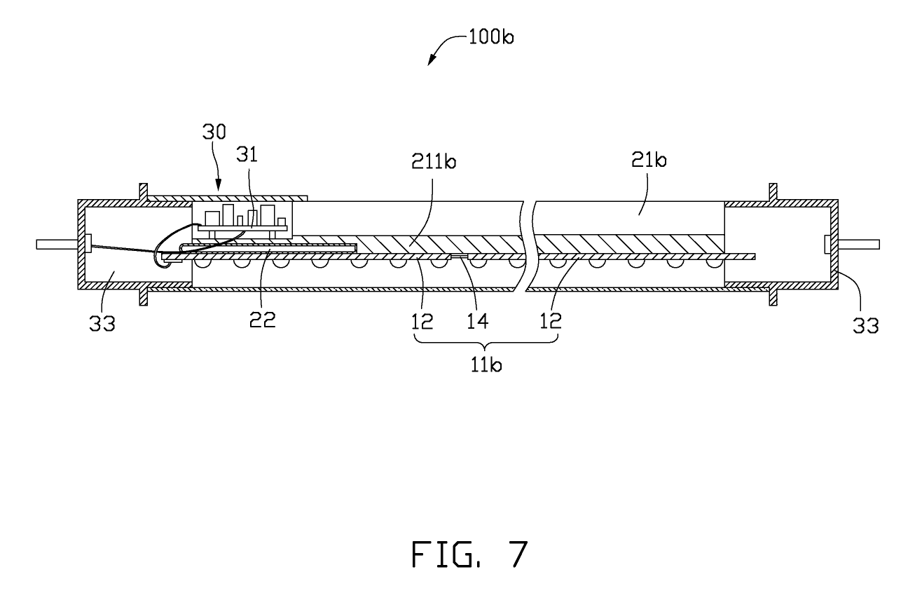

Referring to FIG. 7, an LED illumination device 100b according to another alternative embodiment is illustrated. Except the following differences, the LED illumination device 100b of the present embodiment is essentially the same as LED illumination device 100 of the previous embodiment. In the present embodiment, a light source 11b of the LED illumination device 100b includes at least two light bars 12 as shown in FIG. 3. The light bars 12 are arranged along a base 211b of the heat sink 21b. Two adjacent light bars 12 are electrically connected with each other via a plurality of connecting wires 14. Accordingly, the heat sink 21b is several times longer than the heat sink 21 of the LED illumination device 100, to thereby mount the light bars 12 thereon. Thus, the illumination area and illumination capability of the LED illumination device 100b are greatly expanded.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED illumination device, comprising:
a light-emitting module comprising a light source, the light source being provided with a plurality of LEDs;
a heat sink comprising an elongated base and a plurality of fins extending from the base, the base having a top surface and an opposite bottom surface, the fins extending upwardly from the top surface of the base, the light source being thermally attached to the bottom surface of the base, the heat sink being provided with at least one receiving space at a top side thereof; and an electrical module comprising at least one circuit board and two end covers, the at least one circuit board being accommodated in the at least one receiving space of the heat sink, the two end covers being arranged at two opposite ends of the heat sink.

2. The LED illumination device of claim 1, wherein the at least one receiving space is formed by cutting out a portion of the heat sink at the top side thereof.

3. The LED illumination device of claim 2, wherein the at least one receiving space is provided adjacent to one end of the heat sink.

4. The LED illumination device of claim 1, further comprising at least one heat pipe being sandwiched between the base and the light source, the at least one heat pipe being located under the at least one receiving space, an inner end of the at least one heat pipe extending beyond the receiving space to a position under the fins of the heat sink.

5. The LED illumination device of claim 4, wherein the heat sink defines at least one elongated receiving groove in the bottom surface of the base, the receiving groove being located under the receiving space and extending along a longitudinal direction of the base, the at least one heat pipe being received in the at least one receiving groove of the base.

6. The LED illumination device of claim 5, wherein the heat pipe is flat, and a bottom surface of the heat pipe is coplanar with the bottom surface of the base.

7. The LED illumination device of claim 6, further comprising a protecting cover provided above the at least one receiving space to cover and protect the at least one circuit board.

8. The LED illumination device of claim 1, wherein the light source further comprises at least one elongated substrate attached to the bottom surface of the base, a plurality of electrodes being formed on the at least one substrate, the plurality of LEDs being arranged on the at least one substrate and evenly spaced from each other along the substrate.

9. The LED illumination device of claim 8, wherein each of the two end covers comprises a mounting section at an outer side thereof, a connecting section at an inner side thereof, and a projecting ring between the mounting section and the connecting section, the connecting section defining a receiving room therein and a pair of elongated positioning grooves through inner and outer surfaces thereof, two opposite ends of the at least one substrate respectively extending outwardly beyond two opposite ends of the heat sink and being respectively inserted in the positioning grooves of the two end covers.

10. The LED illumination device of claim 9, wherein the light-emitting module further comprises an elongated optical lens below the light source, the optical lens being C-shaped, an outer surface of the connecting section of each of the two end covers contacting with an inner surface of the optical lens.

11. The LED illumination device of claim 9, wherein a plurality of air venting holes are axially defined in an outer end of the mounting section of each of the two end covers and communicate with the receiving room of the connecting section.

12. The LED illumination device of claim 1, wherein the light-emitting module further comprises an elongated optical lens below the light source, the optical lens has a glazed outer surface and an opposite inner surface, and a plurality of light guiding protrusions are formed on the inner surface of the optical lens and extend along an axial direction of the optical lens.

13. The LED illumination device of claim 1, wherein the electrical module further comprises two pairs of pins located at two opposite ends of the LED illumination device, each of the two end covers being connected with one pair of the pins.

14. The LED illumination device of claim 13, wherein the at least one circuit board is electrically connected to the light source and one pair of the pins.

15. The LED illumination device of claim 1, wherein the light source comprises at least two light bars arranged along the base of the heat sink, each of the at least two light bars comprising an elongated substrate, the plurality of LEDs being arranged on the substrates of the at least two light bars, two adjacent light bars being electrically connected with each other.

16. The LED illumination device of claim 1, wherein the light source comprises two light bars arranged along the base of the heat sink, each of the two light bars comprising an elongated substrate, the plurality of LEDs being arranged on the substrates of the two light bars, the at least one receiving space comprising two receiving spaces located adjacent to two opposite ends of the heat sink, the at least one circuit board comprising two circuit boards respectively accommodated in the two receiving spaces and respectively electrically connected with the two light bars.
